(19) United States
(12) Patent Application Publication
(10) Pub. No.: US 2016/0140652 A1
(43) Pub. Date: May 19, 2016

(54) METHODS AND SYSTEMS FOR DETERMINING AN ASSET DIVESTITURE USING ASSET DATA

(71) Applicant: MasterCard International Incorporated, Purchase, NY (US)

(72) Inventors: Debashis Ghosh, Charlotte, NC (US); Randy Shuken, Westport, CT (US)

(21) Appl. No.: 14/541,390

(22) Filed: Nov. 14, 2014

(51) Int. Cl. G06Q 40/02

(52) U.S. Cl. CPC G06Q 40/02

(57) ABSTRACT

A network-based computer system for determining an asset divestiture of a financial institution based on asset data is described. The system includes at least one processor in communication with at least one memory. The at least one processor is configured to receive a divestiture request message including a financial institution identifier, receive asset data for the identified financial institution, the asset data including data associated with a plurality of assets of the identified financial institution, wherein each asset has an asset value and a risk weight representing a potential change in the asset value over time, determine a candidate divestiture for the identified financial institution at least in part based on the asset value and the risk weight for each asset of the plurality of assets, and provide a divestiture report to the identified financial institution, wherein the divestiture report includes the candidate divestiture for the identified financial institution.

### BACKGROUND

This description relates to analyzing assets held by a financial institution, and more specifically to determining an asset divestiture using asset data.

Financial institutions (e.g., banks, credit unions, insurance companies, and other financial institutions) are subject to regulations, imposed to ensure that a financial institution does not become insolvent. In some cases, financial institutions are required to monitor a ratio of capital to risk. This ratio is often referred to as a capital adequacy ratio (CAR), and is associated with an amount of capital the financial institution must hold.

The CAR for a financial institution is determined, at least in part, using risk-weighted assets (or risk adjusted assets) of the financial institution, where a risk-weighted asset is an asset or off-balance sheet exposure, weighted according to risk. Financial institutions will reduce assets having a higher risk percentage (referred to as high risk-weighted assets) to maintain a CAR in compliance with regulations. For example, a financial institution having high risk-weighted assets may divest (or sell) those assets to improve its CAR. In identifying assets to divest, a financial institution considers the risk and value associated with each asset. It would be beneficial to provide a financial institution with a divestiture summary based on risk-weighted assets of the financial institution to use when determining a CAR (e.g., for regulatory purposes).

### BRIEF DESCRIPTION OF THE DISCLOSURE

In one aspect, a network-based computer system for determining an asset divestiture of a financial institution based on asset data is provided. The system includes at least one processor in communication with at least one memory. The at least one processor is configured to receive a divestiture request message including a financial institution identifier, receive asset data for the identified financial institution, the asset data including data associated with a plurality of assets of the identified financial institution, wherein each asset has an asset value and a risk weight representing a potential change in the asset value over time, determine a candidate divestiture for the identified financial institution at least in part based on the asset value and the risk weight for each asset of the plurality of assets, and provide a divestiture report to the identified financial institution, wherein the divestiture report includes the candidate divestiture for the identified financial institution.

In another aspect, a computer implemented method for determining an asset divestiture of a financial institution based on asset data is provided. The method is implemented using a computing device in communication with a memory. The method includes receiving, by the computing device, a divestiture request message including a financial institution identifier. The method additionally includes receiving, by the computing device, asset data for the identified financial institution, the asset data including data associated with a plurality of assets of the identified financial institution. Each asset has an asset value and a risk weight representing a potential change in the asset value over time. Additionally, the method includes determining a candidate divestiture for the identified financial institution at least in part based on the asset value and the risk weight for each asset of the plurality of assets and providing a divestiture report to the identified financial institution. The divestiture report includes the candidate divestiture for the identified financial institution.

In another aspect, a computer-readable storage medium having computer-executable instructions embodied thereon is provided. When executed by a computing device having one or more processors in communication with one or more memory devices, the computer-executable instructions cause the computing device to receive a divestiture request message including a financial institution identifier, receive asset data for the identified financial institution, the asset data including data associated with a plurality of assets of the identified financial institution, wherein each asset has an asset value and a risk weight representing a potential change in the asset value over time, determine a candidate divestiture for the identified financial institution at least in part based on the asset value and the risk weight for each asset of the plurality of assets, and provide a divestiture report to the identified financial institution, wherein the divestiture report includes the candidate divestiture for the identified financial institution.

### BRIEF DESCRIPTION OF THE DRAWINGS

FIGS. 1-10 show example embodiments of the methods and systems described herein.

FIG. 1 is a schematic diagram illustrating an example multi-party payment card industry system for enabling ordinary payment-by-card transactions in which merchants and card issuers do not necessarily have a one-to-one relationship.

FIG. 2 is a simplified block diagram of an example payment processing system that includes a capital adequacy device and other computing devices in accordance with one example embodiment of the present disclosure.

FIG. 3 is an expanded block diagram of an example embodiment of a server architecture of the payment processing system including the capital adequacy device and a plurality of other computing devices in accordance with one example embodiment of the present disclosure.

FIG. 4 illustrates an example configuration of a client system shown in FIGS. 2 and 3.

FIG. 5 illustrates an example configuration of a server system shown in FIGS. 2 and 3.

FIG. 6 is a block diagram of an example divestiture request message received by the capital adequacy device shown in FIGS. 2 and 3.

FIG. 7 is a block diagram of components of example asset data received by the capital adequacy device shown in FIGS. 2 and 3.

FIG. 8 is a block diagram of an example divestiture report provided by the capital adequacy device shown in FIGS. 2 and 3.

FIG. 9 is a flowchart of an example process that may be performed by the capital adequacy device shown in FIGS. 2 and 3 for determining an asset divestiture of a financial institution based on the example asset data shown in FIG. 7.

FIG. 10 is a diagram of components of one or more example computing devices that may be used in embodiments of the described systems and methods.

### DETAILED DESCRIPTION OF THE DISCLOSURE

Financial institutions oftentimes partner with a payment network to issue payment cards to consumers. Cardholders (e.g., an entity using a payment card such as a credit card, a debit card, or a prepaid card) will initiate payment transactions to pay for purchases from merchants. Transaction data associated with these payment transactions are received and processed over the payment network for processing the payment transactions. The payment network also provides value added services to the financial institution (and the cardholder) as part of the partnership.

In the example system described herein, the payment network includes or is in communication with a capital adequacy device that provides a financial institution with a candidate divestiture based on asset data. More specifically, a payment network computing device is in communication with a capital adequacy device and a memory device. The capital adequacy device is configured to receive asset data for a selected financial institution, determine a candidate divestiture for the selected financial institution at least in part based on the asset data, and provide a divestiture report to the selected financial institution. The divestiture report includes the candidate divestiture for the selected financial institution.

The capital adequacy device is in communication with the payment network. In one embodiment, the capital adequacy device is part of the payment network computing device. In another embodiment, the capital adequacy device is a separate computing device associated with a third-party, and is in communication with the payment network. In either case, the capital adequacy device is configured to (i) receive asset data for a plurality of assets of a selected financial institution, wherein each asset has an asset value and a risk weight; (ii) determine a candidate divestiture for the selected financial institution at least in part based on the asset value and the risk weight for each asset; and (iii) provide a divestiture report based on asset data to the selected financial institution. The divestiture report includes the candidate divestiture for the selected financial institution.

The system as described herein enables a financial institution (e.g., a bank, a credit union, an insurance company, or other financial institution) to submit a divestiture request message including a financial institution identifier to the capital adequacy device. The system receives asset data for a plurality of assets of the identified financial institution based on the information contained within the request message. For each asset, the asset data includes at least an asset value and a risk weight. In one embodiment, the divestiture request message includes a plurality of documents, each document including asset data for one or more asset, and the capital adequacy device processes each document using optical character recognition (OCR) to determine an asset value and a risk weight for the one or more assets based on the asset data. In another embodiment, the asset data are received by the capital adequacy device and stored in an asset database in communication with the system.

The plurality of assets are associated with residential (or commercial) real estate owned by (or otherwise associated with) the identified financial institution. In the example embodiment, each asset is one of an owned real estate (e.g., a branch location of a bank) and an issued loan having real estate as collateral. The asset value is the mark-to-market price of the asset. When the asset is owned real estate, the mark-to-market price is the present day value of the real estate. When the asset is an issued loan, the mark-to-market price is the present day value of the real estate collateral for the loan. In some embodiments, the asset value is the acquiring price of the asset, where the acquiring price is the value of the real estate when it was originally purchased.

The risk weight is associated with the financial volatility of the asset. More specifically, the risk weight represents an amount of potential change in the asset value over time. The risk weight is determined at least in part based on rules promulgated by financial regulators (e.g., the Basel Committee on Banking Supervision), and is often expressed as a percentage. When the asset is owned real estate, the risk weight is 100%. When the asset is an issued loan, the risk weight is less than 100% and is determined using the loan amount and the value of the asset. In the example embodiment, the risk weight for an issued loan is the loan amount divided by the value of the real estate collateral. In some embodiments, the risk weight is received from a separate computing device associated with a third-party. In other embodiments, the asset value and the risk weight are stored in an asset database in communication with the system.

The capital adequacy device determines a capital ratio for each asset of the plurality of assets of the identified financial institution. For each asset, the capital ratio is determined using the asset value and the risk weight of the asset. In the example embodiment, the capital ratio for each asset is determined by multiplying the asset value and the risk weight of the asset. For example, the capital ratio for an owned real estate having an asset value of 5 and a risk weight of 100% is 5, and the capital ratio for an issued loan having an asset value of 5 and a risk weight of 50% is 2.5. In some embodiments, the capital adequacy device aggregates capital ratios for each asset and determines a CAR of the identified financial institution based at least in part on the aggregated capital ratios. In yet other embodiments, reducing the capital ratio for one or more asset will improve a CAR of the identified financial institution.

The capital adequacy device also determines a candidate divestiture for the identified financial institution. The candidate divestiture may be divested to improve a CAR of the identified financial institution. The candidate divestiture is an asset of the plurality of assets of the financial institution, and is determined by the capital adequacy device using at least one of the capital ratio, the asset value, and the risk weight of each asset. When the candidate divestiture is an owned real estate, the owned real estate may be sold, or sold and leased back, to improve a CAR of the identified financial institution. When the candidate divestiture is an issued loan, the issued loan may be sold to improve a CAR of the identified financial institution. In some embodiments, the candidate divestiture may be divested to improve the net operating income of the identified financial institution. In other embodiments, the system enables the identified financial institution to provide the candidate divestiture to a prospect financial institution that may acquire the respective asset from the identified financial institution.

The device provides a divestiture report to the identified financial institution including the candidate divestiture. The divestiture report may be provided by an electronic communication (e.g., an email), or by an interface (e.g., a website) accessible by the identified financial institution. For example, a financial institution wishes to determine a CAR for regulatory purposes. In determining the CAR, the financial institution submits a divestiture request message including a plurality of assets of the financial institution to the capital adequacy device, and the device provides a divestiture report to the financial institution based on at least the content of the received request message. In one embodiment, the divestiture report further includes the capital ratio for each asset of the plurality of assets of the identified financial institution. In another embodiment, the divestiture report further includes the asset value and the risk weight for each asset of the plurality of assets of the identified financial institution.

In some embodiments, the system receives asset data for a candidate financial institution when the candidate financial institution provides, or has previously provided, authorization for the capital adequacy device to access the data. In other embodiments, a candidate financial institution is a registered financial institution that registers with a subscription service of the capital adequacy system to provide authorization for the system to receive the data.

The methods and systems described herein may be implemented using computer programming or engineering techniques including computer software, firmware, hardware or any combination or subset thereof, to perform one or more of the following: (a) receiving, by a computing device, a divestiture request message including a financial institution identifier; (b) receiving, by the computing device, asset data for the identified financial institution, the asset data including data associated with a plurality of assets of the identified financial institution, wherein each asset has an asset value and a risk weight representing a potential change in the asset value over time; (c) determining a candidate divestiture for the identified financial institution at least in part based on the asset value and the risk weight for each asset of the plurality of assets; and (d) providing a divestiture report to the identified financial institution, wherein the divestiture report includes the candidate divestiture for the identified financial institution. The methods and systems described herein provide the technical effect of processing data pertaining to multiple assets held by a financial institution and enabling the financial institution to reduce its risk to a predetermined threshold by selectively divesting one or more of the assets.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, smartphones, personal digital assistants (PDAs), key fobs, and/or computers. Each type of transaction card can be used as a method of payment for performing a transaction.

In one embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

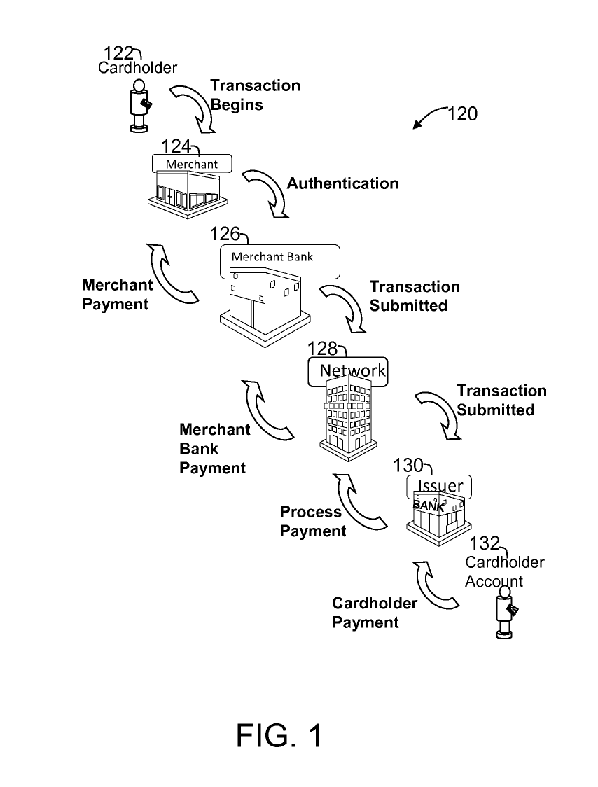

FIG. 1 is a schematic diagram illustrating an example multi-party payment card system 120 for enabling ordinary payment-by-card transactions in which merchants and card issuers do not necessarily have a one-to-one relationship. The present disclosure relates to payment card system 120, such as a credit card payment system using the MasterCard® payment card system payment network 128 (also referred to as an “interchange” or “interchange network”). MasterCard® payment card system payment network 128 is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In payment card system 120, a financial institution such as an issuer 130 issues a payment card for an account, such as a credit card account or a debit card account, to a cardholder 122, who uses the payment card to tender payment for a purchase from a merchant 124. To accept payment with the payment card, merchant 124 must normally establish an account with a financial institution that is part of the financial payment system. This financial institution is usually called the “merchant bank” or the “acquiring bank” or “acquirer bank” or simply “acquirer”. When a cardholder 122 tenders payment for a purchase with a payment card (also known as a financial transaction card), merchant 124 requests authorization from acquirer 126 for the amount of the purchase. Such a request is referred to herein as an authorization request message. The request may be performed over the telephone, but is usually performed through the use of a point-of-interaction terminal, also referred to herein as a point-of-sale device, which reads the cardholder's account information from the magnetic stripe on the payment card and communicates electronically with the transaction processing computers of acquirer 126. Alternatively, acquirer 126 may authorize a third party to perform transaction processing on its behalf. In this case, the point-of-interaction terminal will be configured to communicate with the third party. Such a third party is usually called a “merchant processor” or an “acquiring processor.”

Using payment card system payment network 128, the computers of acquirer 126 or the merchant processor will communicate with the computers of issuer 130, to determine whether the cardholder's account 132 is in good standing and whether the purchase is covered by the cardholder's available credit line or account balance. Based on these determinations, the request for authorization will be declined or accepted. If the request is accepted, an authorization code is issued to merchant 124.

When a request for authorization is accepted, the available credit line or available balance of cardholder's account 132 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the products or services, merchant 124 captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For debit card transactions, when a request for authorization is approved by the issuer, the cardholder's account 132 is decreased. Normally, a charge is posted immediately to cardholder's account 132. The bankcard association then transmits the approval to the acquiring processor for distribution of products/services, or information or cash in the case of an ATM.

After a transaction is captured, the transaction is settled between merchant 124, acquirer 126, and issuer 130. Settlement refers to the transfer of financial data or funds between the merchant's account, acquirer 126, and issuer 130 related to the transaction. Usually, transactions are captured and accumulated into a “batch,” which is settled as a group.

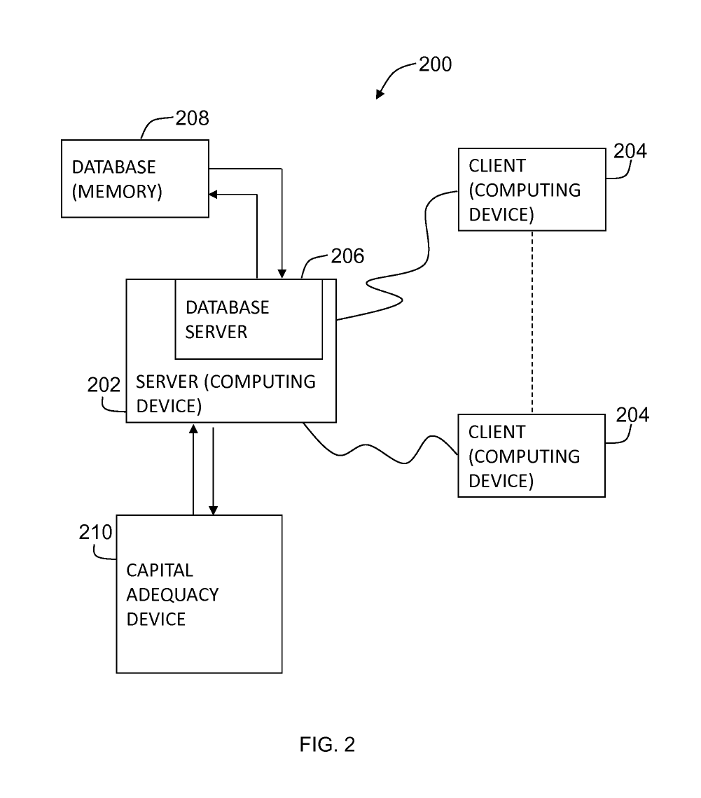

FIG. 2 is a simplified block diagram of a payment processing system 200 that includes a capital adequacy device 210 and other computing devices in accordance with one embodiment of the present disclosure. In the example embodiment, system 200 includes a server system 202 and a plurality of client subsystems, also referred to as client systems 204 or client computing devices, connected to server system 202. In one embodiment, client systems 204 are computers including a web browser, such that server system 202 is accessible to client systems 204 using the Internet. Client systems 204 are interconnected to the Internet through many interfaces including a network, such as a local area network (LAN) and/or a wide area network (WAN), dial-in connections, cable modems, wireless-connections, and special high-speed ISDN lines. Client systems 204 may be any device capable of interconnecting to the Internet including a web-based phone, personal digital assistant (PDA), or other web-connectable equipment. A database server 206 is connected to a database 208 containing information on a variety of matters, as described below in greater detail. In one embodiment, database 208 is stored on server system 202 and may be accessed by potential users at one of client systems 204 by logging onto server system 202 through one of client systems 204. Database 208 is also accessible to capital adequacy device 210. In any alternative embodiment, database 208 is stored remotely from server system 202 and may be non-centralized. Server system 202 could be any type of computing device configured to perform the steps described herein. Additionally, capital adequacy device 210 is in communication with server system 202. In some implementations, capital adequacy device 210 is incorporated into or integrated within server system 202.

As discussed below, payment processing system 200 processes payments from transactions between cardholders and merchants. Additionally, capital adequacy device 210, which is communicatively coupled to and/or incorporated within payment processing system 200 receives a divestiture request message from a financial institution. For example, capital adequacy device 210 receives a divestiture request message from a client computing device 204 associated with a financial institution (e.g., a bank, a credit union, or an insurance company). At least in some implementations, the divestiture request message includes asset data that capital adequacy device 210 then stores in database 208 (also referred to herein as an “asset database”). In other implementations, capital adequacy device 210 receives the asset data from a third party (e.g., client computing device 204). Capital adequacy device 210 then determines a candidate divestiture for the financial institution, based on the asset data, and provides a divestiture report to the financial institution. The divestiture report identifies at least one asset from the asset data as an asset that the financial institution should sell off to improve the CAR of the financial institution. These processes are described in more detail herein.

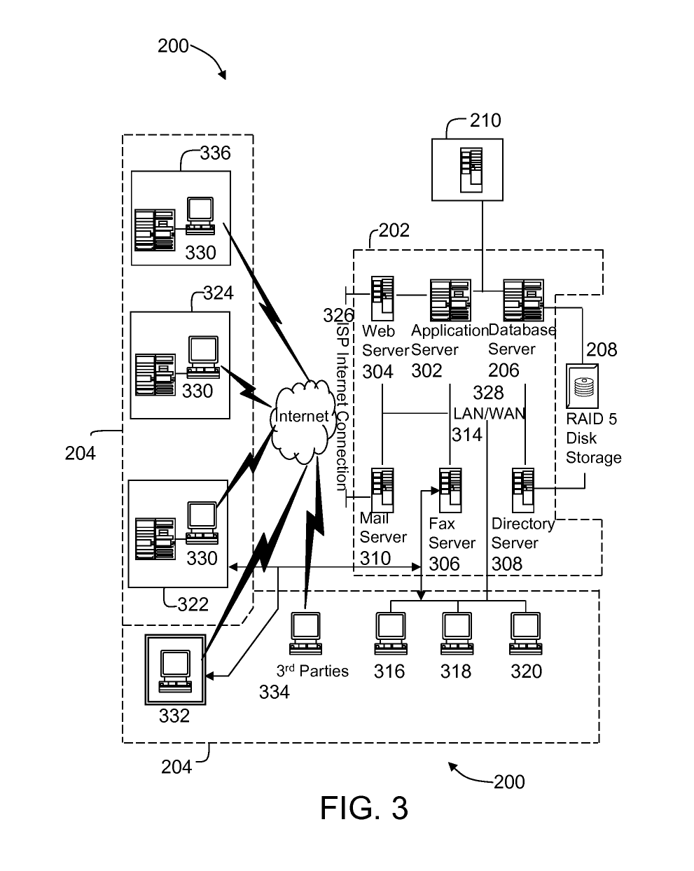

FIG. 3 is an expanded block diagram of an example embodiment of a server architecture of payment processing system 200 in accordance with one embodiment of the present disclosure. Payment processing system 200 includes server system 202, client systems 204, and capital adequacy device 210. Server system 202 includes database server 206, an application server 302, a web server 304, a fax server 306, a directory server 308, and a mail server 310. Database 208 (e.g., a disk storage unit), is coupled to database server 206 and directory server 308. Servers 206, 302, 304, 306, 308, and 310 are coupled in a local area network (LAN) 314. In addition, a system administrator's workstation 316, a user workstation 318, and a supervisor's workstation 320 are coupled to LAN 314. Alternatively, workstations 316, 318, and 320 are coupled to LAN 314 using an Internet link or are connected through an Intranet.

Each workstation, 316, 318, and 320, is a personal computer having a web browser. Although the functions performed at the workstations typically are illustrated as being performed at respective workstations 316, 318, and 320, such functions can be performed at one of many personal computers coupled to LAN 314. Workstations 316, 318, and 320 are illustrated as being associated with separate functions only to facilitate an understanding of the different types of functions that can be performed by individuals having access to LAN 314.

Server system 202 is configured to be communicatively coupled to various entities, including acquirers 322, issuers 324, and third parties 334 using an Internet connection 326. Server system 202 is also communicatively coupled with at least one financial institution 336. Server system 202 is also communicatively coupled to capital adequacy device 210. In some embodiments, capital adequacy device 210 is integrated within server system 202. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 328, local area network 314 could be used in place of WAN 328.

In the example embodiment, any authorized individual or entity having a workstation 330 may access system 200. At least one of the client systems includes a manager workstation 332 located at a remote location. Workstations 330 and 332 include personal computers having a web browser. Also, workstations 330 and 332 are configured to communicate with server system 202. Furthermore, fax server 306 communicates with remotely located client systems, including a client system 332, using a telephone link. Fax server 306 is configured to communicate with other client systems 316, 318, and 320 as well.

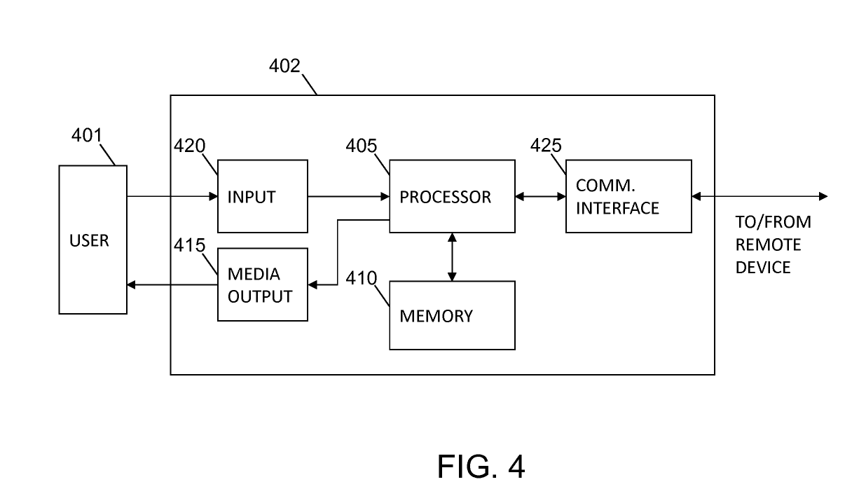

FIG. 4 illustrates an example configuration of a cardholder computing device 402 operated by a user 401. User 401 may include cardholder 122 (FIG. 1). Cardholder computing device 402 may include, but is not limited to, client systems (“client computing devices”) 204, 316, 318, and 320, workstation 330, and manager workstation 332 (shown in FIG. 3).

Cardholder computing device 402 includes one or more processors 405 for executing instructions. In some embodiments, executable instructions are stored in a memory area 410. Processor 405 may include one or more processing units (e.g., in a multi-core configuration). One or more memory devices 410 are any one or more devices allowing information such as executable instructions and/or other data to be stored and retrieved. One or more memory devices 410 may include one or more computer-readable media.

Cardholder computing device 402 also includes at least one media output component 415 for presenting information to user 401. Media output component 415 is any component capable of conveying information to user 401. In some embodiments, media output component 415 includes an output adapter such as a video adapter and/or an audio adapter. An output adapter is operatively coupled to processor 405 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, cardholder computing device 402 includes an input device 420 for receiving input from user 401. Input device 420 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 415 and input device 420.

Cardholder computing device 402 may also include a communication interface 425, which is communicatively couplable to a remote device such as server system 202 or a web server operated by a merchant. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in one or more memory devices 410 are, for example, computer-readable instructions for providing a user interface to user 401 via media output component 415 and, optionally, receiving and processing input from input device 420. A user interface may include, among other possibilities, a web browser and client application. Web browsers enable users, such as user 401, to display and interact with media and other information typically embedded on a web page or a website from server system 202 or a web server associated with a merchant. A client application allows user 401 to interact with a server application from server system 202 or a web server associated with a merchant.

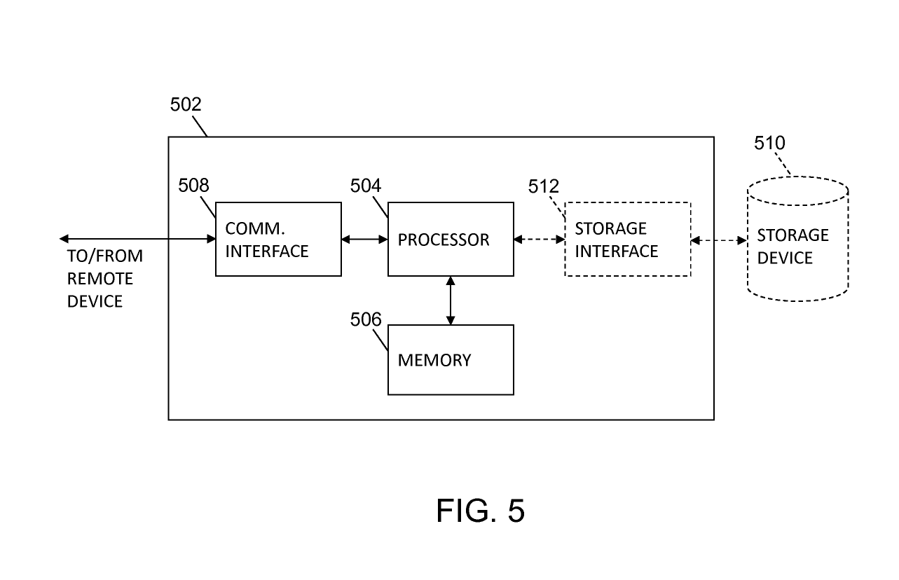

FIG. 5 illustrates an example configuration of a server computing device 502 such as server system 202 (shown in FIGS. 2 and 3). Server computing device 502 may include, but is not limited to, database server 206, application server 302, web server 304, fax server 306, directory server 308, and mail server 310. Server computing device 502 is also representative of capital adequacy device 210.

Server computing device 502 includes one or more processors 504 for executing instructions. Instructions may be stored in one or more memory devices 506, for example. One or more processors 504 may include one or more processing units (e.g., in a multi-core configuration).

One or more processors 504 are operatively coupled to a communication interface 508 such that server computing device 502 is capable of communicating with a remote device such as cardholder computing device 402 or another server computing device 502. For example, communication interface 508 may receive requests from client systems 204 via the Internet, as illustrated in FIGS. 2 and 3.

One or more processors 504 may also be operatively coupled to one or more storage devices 510. One or more storage devices 510 are any computer-operated hardware suitable for storing and/or retrieving data. In some embodiments, one or more storage devices 510 are integrated in server computing device 502. For example, server computing device 502 may include one or more hard disk drives as one or more storage devices 510. In other embodiments, one or more storage devices 510 are external to server computing device 502 and may be accessed by a plurality of server computing devices 502. For example, one or more storage devices 510 may include multiple storage units such as hard disks or solid state disks in a redundant array of inexpensive disks (RAID) configuration. One or more storage devices 510 may include a storage area network (SAN) and/or a network attached storage (NAS) system. In some embodiments, one or more storage devices 510 may include database 208.

In some embodiments, one or more processors 504 are operatively coupled to one or more storage devices 510 via a storage interface 512. Storage interface 512 is any component capable of providing one or more processors 504 with access to one or more storage devices 510. Storage interface 512 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing one or more processors 504 with access to one or more storage devices 510.

One or more memory devices 410 and 506 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

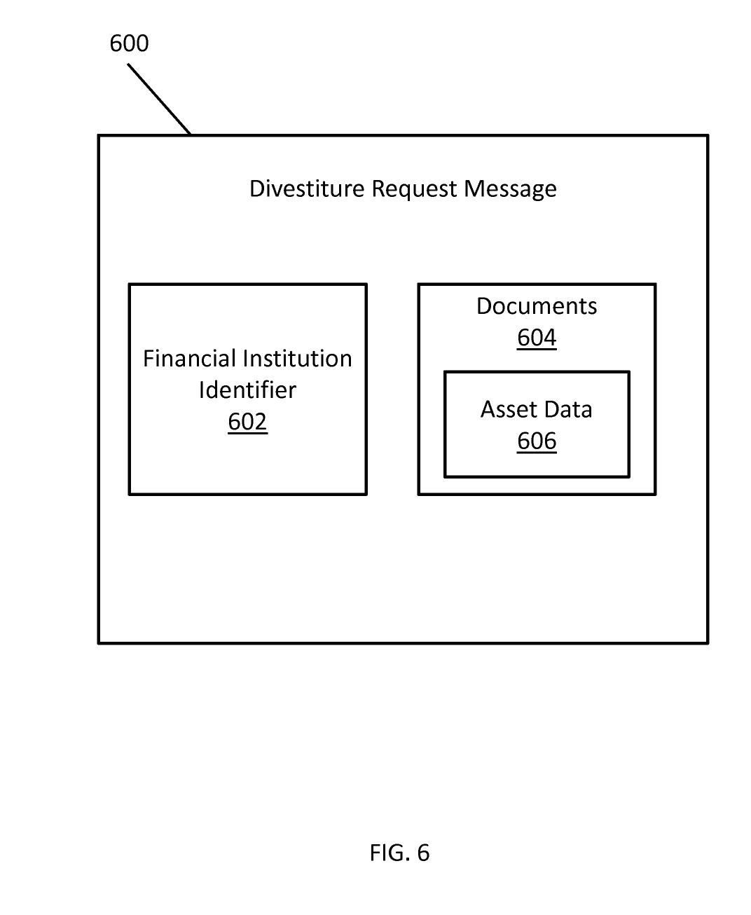

FIG. 6 is a block diagram of an example divestiture request message 600 received by capital adequacy device 210. More specifically, capital adequacy device 210 receives divestiture request message 600 from financial institution 336. Financial institution 336 transmits divestiture request message 600 to capital adequacy device 210 directly or through payment network 128. Divestiture request message 600 includes an identifier 602 of financial institution 336 and asset data 606. In at least some implementations, asset data 606 is included in one or more documents 604 that are included in divestiture request message 600. In some implementations, capital adequacy device 210 performs optical character recognition on documents 604 to extract asset data 606 from documents 604.

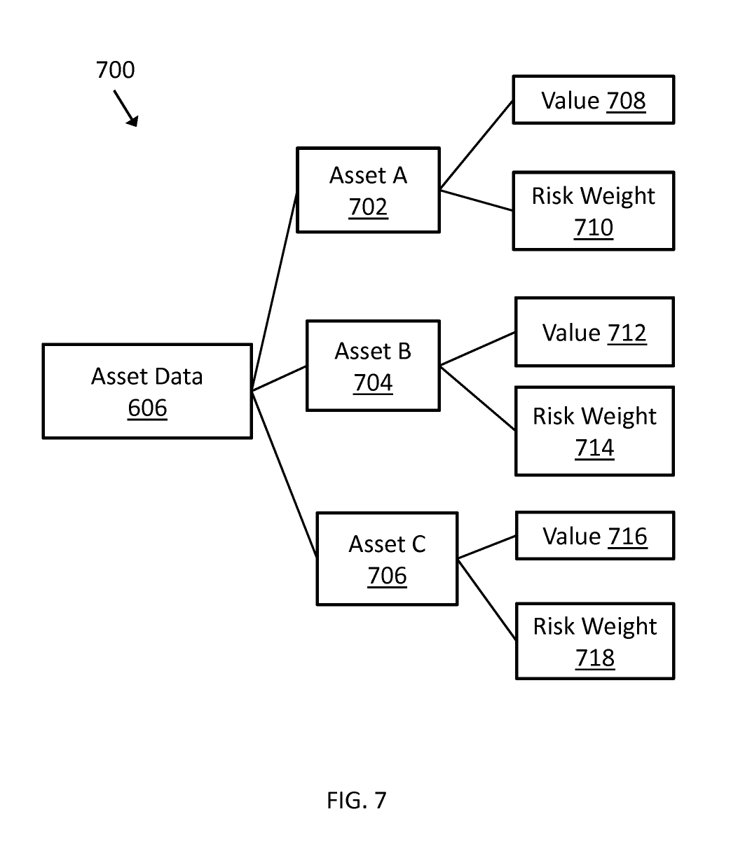

FIG. 7 is a block diagram 700 of components of asset data 606 received by the capital adequacy device 210. Asset data 606 includes asset A 702, asset B 704, and asset C 706. One or more of assets 702, 704, and 706 is real estate owned by financial institution 336. For example, asset A 702 is a branch office of financial institution 336. Another one of the assets 702, 704, and 706, for example asset B 704, is a loan in which real estate is the collateral. Each asset 702, 704, and 706 has an associated value and risk weight. More specifically, asset A 702 is associated with value 708 and risk weight 710, asset B 704 is associated with value 712 and risk weight 714, and asset C 706 is associated with value 716 and risk weight 718. Each value 708, 712, and 716, is a mark-to-market price of the respective asset 702, 704, and 706. When the asset is owned real estate (e.g., asset A 702), capital adequacy device 210 determines that the mark-to-market price is the present day value of the real estate. When the asset is an issued loan (e.g., asset B 704), capital adequacy device 210 determines that the mark-to-market price is the present day value of the real estate collateral for the loan. In some implementations, capital adequacy device 210 determines that the asset value (e.g., for asset A 702) is the acquiring price of the asset, where the acquiring price is the value of the real estate when it was originally purchased by financial institution 336.

Each risk weight 710, 714, and 718 is associated with the financial volatility of the respective asset 702, 704, and 706. Capital adequacy device 210 determines the risk weight at least in part based on rules promulgated by financial regulators (e.g., the Basel Committee on Banking Supervision). In some implementations, capital adequacy device 210 determines and stores each risk weight 710, 714, and 718 as a percentage. For example, in some implementations, if the asset is owned real estate (e.g., asset A 702), capital adequacy device 210 determines that the corresponding risk weight 710 is 100%. When the asset is an issued loan (e.g., asset B 704), capital adequacy device 210 determines that the corresponding risk weight 714 is less than 100%. More specifically, capital adequacy device 210 determines the corresponding risk weight 714 using the loan amount and value 712 of asset B 704. In one implementation, capital adequacy device 210 determines that the risk weight 714 for an issued loan (e.g., asset B 714) is the loan amount divided by the value 712 of the real estate collateral. In some implementations, capital adequacy device 210 receives the asset values 708, 712, and/or 716 and/or the risk weights 710, 714, and/or 718 from a separate computing device associated with a third-party (e.g., third party 334). In some implementations, capital adequacy device 210 stores asset values 708, 712, and 716 and risk weights 710, 714, and 718 in database 208, for example in association with financial institution identifier 602 (FIG. 6).

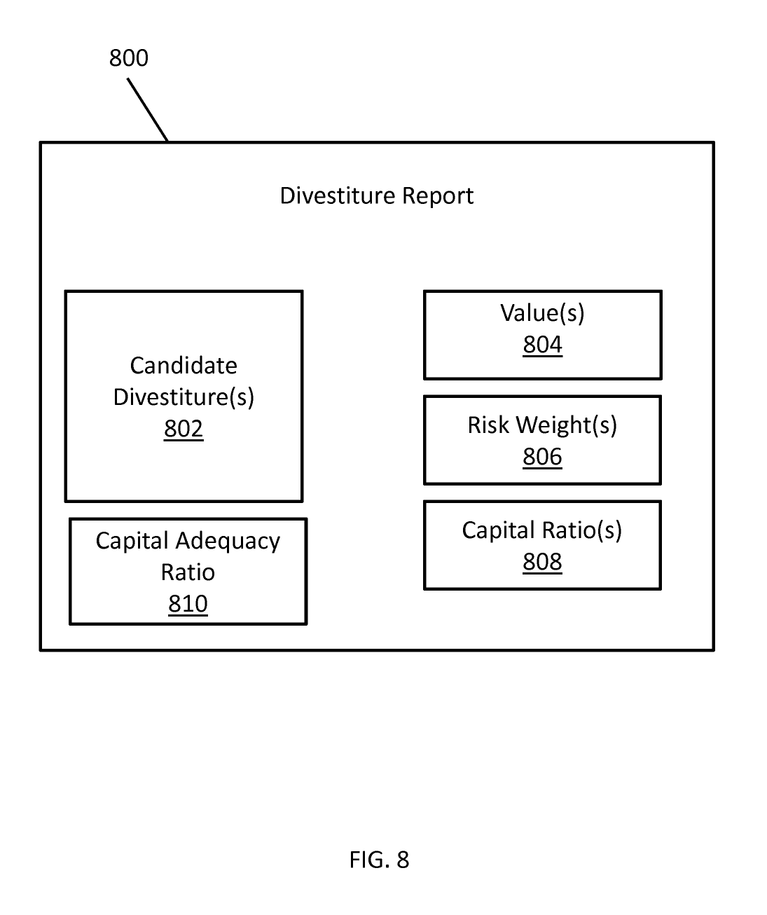

FIG. 8 is a block diagram of an example divestiture report 800 provided by capital adequacy device 210. More specifically, in response to receiving divestiture request message 600 (FIG. 6) from financial institution 336, capital adequacy device 210 provides (e.g., transmits) divestiture report 800 to financial institution 336, identifying at least one asset (e.g., asset A 702) as a candidate divestiture 802, and at least in some implementations, including one or more values 804 (e.g., value 708, value 712, and/or value 716), risk weights 806 (e.g., risk weight 710, risk weight 714, and/or risk weight 718), and/or capital ratios 808. Divestiture report 800 recommends that financial institution 336 sell off the candidate divestiture 802 in order to improve the CAR of financial institution 336. In at least some implementations, in generating divestiture report 800, capital adequacy device 210 determines a capital ratio 808 for each asset 702, 704, and 706 of the plurality of assets held by financial institution 336. For each asset, for example asset A 702, capital adequacy device 210 determines the corresponding capital ratio 808 using the respective value 708 and the respective risk weight 710. In some implementations, capital adequacy device 210 determines capital ratio 808 for each asset, for example asset A 702, by multiplying the respective value 708 by the respective risk weight 710. For example, the capital ratio 808 for an owned real estate (e.g., asset A 702) having an asset value 708 of 5 and a risk weight 710 of 100% is 5, and the capital ratio for an issued loan (e.g., asset B 704) having an asset value 712 of 5 and a risk weight 714 of 50% is 2.5. In some implementations, capital adequacy device 210 aggregates capital ratios 808 for each asset (e.g., asset A 702, asset B 704, and asset C 706) and determines a CAR 810 of financial institution 336 based at least in part on the aggregated capital ratios 808. In some implementations, capital adequacy device indicates in divestiture report 800 that reducing the capital ratio 808 for one or more assets 702, 704, 706 will improve CAR 810 of financial institution 336.

As described above, capital adequacy device 210 determines candidate divestiture 802 for financial institution 336. Candidate divestiture 802 may be divested to improve CAR 810 of financial institution 336. For example, if candidate divestiture 802 is an owned real estate (e.g., asset A 702), the owned real estate (e.g., asset A 702) may be sold by financial institution 336, or sold and leased back by financial institution 336, to improve CAR 810. When candidate divestiture 802 is an issued loan (e.g., asset B 704), the issued loan (e.g., asset B 704) may be sold by financial institution 336 to improve CAR 810. In some implementations, capital adequacy device 210 may determine that candidate divestiture 802 may be divested to improve the net operating income of financial institution 336, for example based on transaction data stored in database 208 indicating net operating income (e.g., rent) paid to financial institution 336 as a result of owning the asset (e.g., asset A 702). In some implementations, capital adequacy device 210 transmits data, for example an identifier, of one or more assets (e.g., asset A 702) to a prospect financial institution that may be interested in purchasing the respective asset (e.g., asset A 702) from financial institution 336.

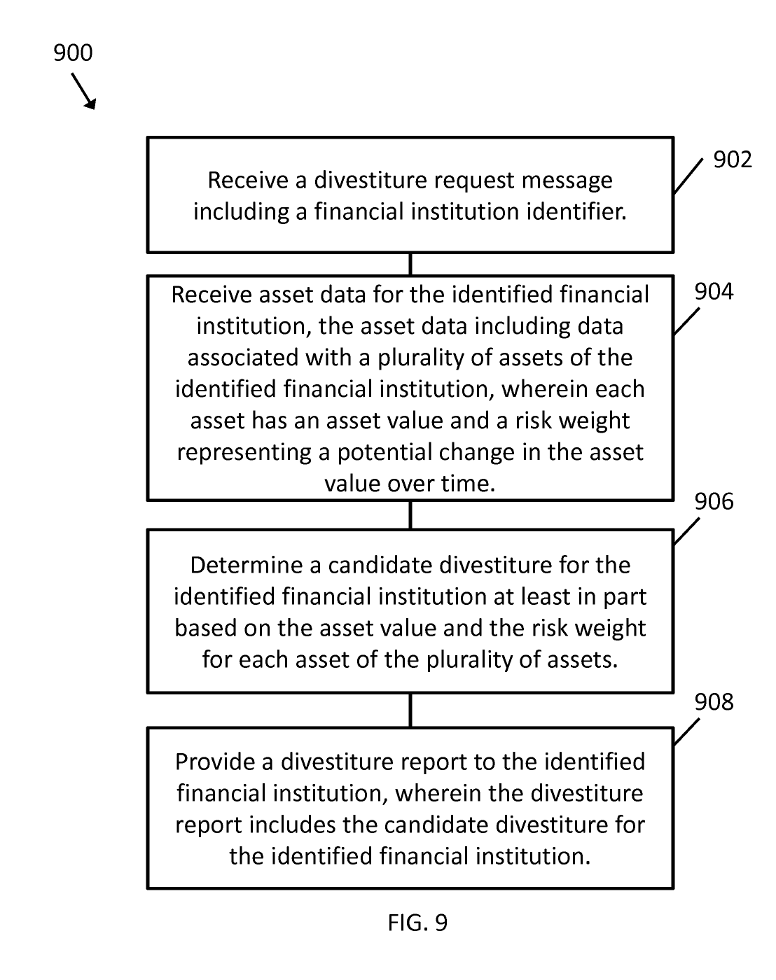

FIG. 9 is a flowchart of an example process 900 that may be performed by a network-based computer system (e.g., capital adequacy device 210) for determining an asset divestiture of a financial institution based on asset data. Initially, capital adequacy device 210 receives 902 a divestiture request message (e.g., divestiture request message 600) including a financial institution identifier 602, for example a name, address, number, or other identifier associated with financial institution 336. Additionally, capital adequacy device 210 receives 904 asset data (e.g., asset data 606) for the identified financial institution (e.g., financial institution 336). The asset data (e.g., asset data 606) includes data associated with a plurality of assets (e.g., asset A 702, asset B 704, and asset C 706) of the identified financial institution (e.g., financial institution 336), wherein each asset has an asset value (e.g., values 708, 712, and 716) and a risk weight (e.g., risk weights 710, 714, 718). Additionally, capital adequacy device 210 determines 906 a candidate divestiture (e.g., candidate divestiture 802) for the identified financial institution (e.g., financial institution 336) at least in part based on the asset value (e.g., value 708, value 712, and value 716) and the risk weight (e.g., risk weight 710, risk weight 714, and risk weight 718) for each asset of the plurality of assets (e.g., asset A 702, asset B 704, and asset C 706). Additionally, capital adequacy device 210 provides 908 a divestiture report (e.g., divestiture report 800) to the identified financial institution (e.g., financial institution 336), wherein the divestiture report (e.g., divestiture report 800) includes the candidate divestiture (e.g., candidate divestiture 802) for the identified financial institution (e.g., financial institution 336).

In some implementations, capital adequacy device 210 additionally retrieves stored payment transaction data (e.g., transaction data section 1018 in database 208) associated with at least one asset of the plurality of assets (e.g., asset A 702), determines a net operating income based at least in part on the stored payment transaction data, and determines candidate divestiture 802 based additionally on the determined net operating income associated with the at least one asset (e.g., asset A 702). In some implementations, capital adequacy device 210 additionally aggregates capital ratios 808 for each of the plurality of assets 702, 704, and 706, and determines a CAR 810 of the identified financial institution 336 based at least in part on the aggregated capital ratios 808. In some implementations, capital adequacy device 210 additionally receives at least one document 604 that includes asset data 606 and obtains asset data 606 from the at least one document 604 by performing optical character recognition on the at least one document 604. In some implementations, capital adequacy device 210 additionally determines the asset value (e.g., value 708) associated with at least one of the plurality of assets (e.g., asset A 702) by determining an acquiring price when the asset was originally purchased. In some implementations, capital adequacy device 210 additionally determines that at least one of the plurality of assets (e.g., asset B 704) is an issued loan having real estate as collateral and determines the risk weight (e.g., risk weight 714) associated with the at least one asset (e.g., asset B 704) by dividing a loan amount associated with the loan by the value of the real estate collateral.

In some implementations, capital adequacy device 210 additionally determines a capital ratio 808 for each of the plurality of assets (e.g., assets 702, 704, and 706) by multiplying the asset value (e.g., values 708, 712, and 716) by the risk weight (e.g., risk weights 710, 714, and 718) associated with each respective asset. In some implementations, capital adequacy device 210 additionally determines the candidate divestiture 802 by determining a capital ratio 808 for each of the plurality of assets, identifying one of the plurality of assets (e.g., asset A 702) as having the highest capital ratio of the plurality of assets, and determining that the asset (e.g., asset A 702) having the highest capital ratio is the candidate divestiture 802. In some implementations, capital adequacy device 210 identifies at least one of the plurality of assets (e.g., asset A 702) as the candidate divestiture 802, includes at least one of a capital ratio 808, the risk weight 710, and the asset value 708 associated with the at least one of the plurality of assets (e.g., asset A 702) in the divestiture report 800, and transmits the divestiture report 800 to a financial institution computing device (e.g., client computing device 204) associated with the financial institution 336.

In some implementations, capital adequacy device 210 determines the asset value (e.g., value 708) associated with at least one of the plurality of assets (e.g., asset A 702) by determining a mark-to-market price of the at least one asset. In some implementations, capital adequacy device 210 determines the mark-to-market price by determining that the at least one asset is real estate owned by the financial institution 336 and determining a present day value of the real estate as the mark-to-market price associated with the at least one asset (e.g., asset A 702). In some implementations, capital adequacy device 210 determines the mark-to-market price by determining that the at least one asset (e.g., asset B 704) is an issued loan having real estate as collateral for the issued loan and determining a present day value of the real estate as the mark-to-market price associated with the at least one asset (e.g., asset B 704).

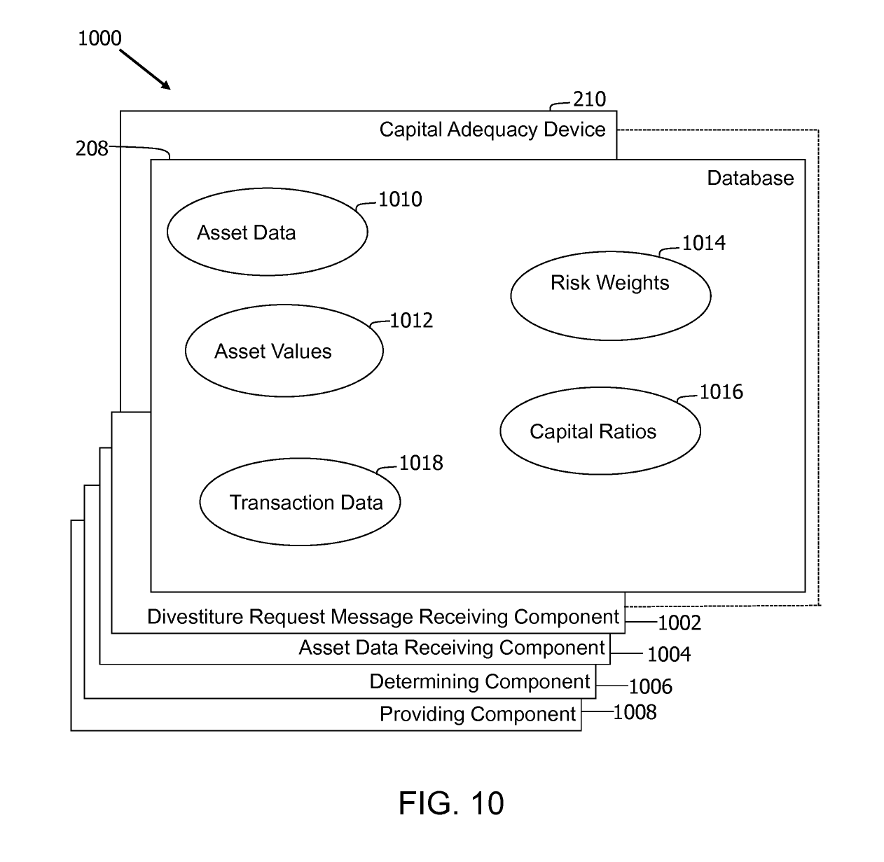

FIG. 10 is a diagram 1000 of components of one or more example computing devices, for example capital adequacy device 210, that may be used in embodiments of the described systems and methods. FIG. 10 further shows a configuration of database 208 (FIG. 2). Database 208 is communicatively coupled to capital adequacy device 210.

Capital adequacy device 210 includes a divestiture request message receiving component 1002 for receiving a divestiture request message 600 including a financial institution identifier 602. Capital adequacy device 210 additionally includes an asset data receiving component 1004 for receiving asset data 606 for the identified financial institution 336, the asset data 606 including data associated with a plurality of assets 702, 704, and 706 of the identified financial institution 336, wherein each asset 702, 704, and 706 has an asset value 708, 712, and 716 and a risk weight 710, 714, and 718. Additionally, capital adequacy device 210 includes a determining component 1006 for determining a candidate divestiture 802 for the identified financial institution 336 at least in part based on the asset value 708, 712, and 716 and a risk weight 710, 714, and 718 for each asset of the plurality of assets 702, 704, and 706. Capital adequacy device 210 also includes a providing component 1008 for providing a divestiture report 800 to the identified financial institution 336, wherein the divestiture report 800 includes the candidate divestiture 802 for the identified financial institution 336.

In an example embodiment, database 208 is divided into a plurality of sections, including but not limited to, an asset data section 1010, an asset values section 1012, a risk weights section 1014, a capital ratios section 1016, and a transaction data section 1018. These sections within database 208 are interconnected to retrieve and store information in accordance with the functions and processes described above.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 405, 504, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

The embodiments of the method and system described above provide a financial institution with a recommendation of one or more assets to divest in order to reduce an amount of risk carried by the financial institution. Accordingly, as compared to known systems, the systems and methods described herein may enable a financial institution to make a more informed decision as to which asset or assets to sell off to improve the financial institution's CAR and/or increase the amount of money the financial institution can loan out while maintaining a particular CAR.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A network-based computer system for determining an asset divestiture of a financial institution based on asset data, said system comprising at least one processor in communication with at least one memory, said at least one processor configured to:
receive a divestiture request message including a financial institution identifier;
receive asset data for the identified financial institution, the asset data including data associated with a plurality of assets of the identified financial institution, wherein each asset has an asset value and a risk weight representing a potential change in the asset value over time;
determine a candidate divestiture for the identified financial institution at least in part based on the asset value and the risk weight for each asset of the plurality of assets; and
provide a divestiture report to the identified financial institution, wherein the divestiture report includes the candidate divestiture for the identified financial institution.

2. The system of claim 1, wherein said system is in communication with a payment network and said at least one processor is further configured to:
retrieve stored payment transaction data associated with at least one asset of the plurality of assets;
determine a net operating income based at least in part on the stored payment transaction data; and
determine the candidate divestiture based additionally on the determined net operating income associated with the at least one asset.

3. The system of claim 1, wherein said at least one processor is further configured to:
aggregate capital ratios for each of the plurality of assets; and
determine a capital adequacy ratio of the identified financial institution based at least in part on the aggregated capital ratios.

4. The system of claim 1, wherein said at least one processor is further configured to:
receive at least one document that includes the asset data; and
obtain the asset data from the at least one document by performing optical character recognition on the at least one document.

5. The system of claim 1, wherein said at least one processor is further configured to determine the asset value associated with at least one of the plurality of assets by determining an acquiring price when the asset was originally purchased.

6. The system of claim 1, wherein said at least one processor is further configured to:
determine that at least one of the plurality of assets is an issued loan having real estate as collateral; and
determine the risk weight associated with the at least one asset by dividing a loan amount associated with the loan by the value of the real estate collateral.

7. The system of claim 1, wherein said at least one processor is further configured to determine a capital ratio for each of the plurality of assets by multiplying the asset value by the risk weight associated with each respective asset.

8. The system of claim 1, wherein said at least one processor is further configured to determine the candidate divestiture by:
determining a capital ratio for each of the plurality of assets;
identifying one of the plurality of assets as having the highest capital ratio of the plurality of assets; and
determining that the asset having the highest capital ratio is the candidate divestiture.

9. The system of claim 1, wherein said at least one processor is further configured to:
identify at least one of the plurality of assets as the candidate divestiture;
include at least one of a capital ratio, the risk weight, and the asset value associated with the at least one of the plurality of assets in the divestiture report; and
transmit the divestiture report to a financial institution computing device associated with the financial institution.

10. A computer implemented method for determining an asset divestiture of a financial institution based on asset data, said method implemented using a computing device in communication with a memory, said method comprising:
receiving, by the computing device, a divestiture request message including a financial institution identifier;
receiving, by the computing device, asset data for the identified financial institution, the asset data including data associated with a plurality of assets of the identified financial institution, wherein each asset has an asset value and a risk weight representing a potential change in the asset value over time;
determining a candidate divestiture for the identified financial institution at least in part based on the asset value and the risk weight for each asset of the plurality of assets; and
providing a divestiture report to the identified financial institution, wherein the divestiture report includes the candidate divestiture for the identified financial institution.

11. The method of claim 10, further comprising determining the asset value associated with at least one of the plurality of assets by determining a mark-to-market price of the at least one asset.

12. The method of claim 11, wherein determining the mark-to-market price further comprises:
determining that the at least one asset is real estate owned by the financial institution; and
determining a present day value of the real estate as the mark-to-market price associated with the at least one asset.

13. The method of claim 11, wherein determining the mark-to-market price further comprises:
determining that the at least one asset is an issued loan having real estate as collateral for the issued loan; and
determining a present day value of the real estate as the mark-to-market price associated with the at least one asset.

14. The method of claim 10, further comprising determining the asset value associated with at least one of the plurality of assets by determining an acquiring price when the asset was originally purchased.

15. The method of claim 10, further comprising:
determining that at least one of the plurality of assets is an issued loan having real estate as collateral; and
determining the risk weight associated with the at least one asset by dividing a loan amount associated with the loan by the value of the real estate collateral.

16. The method of claim 10, further comprising determining a capital ratio for each of the plurality of assets by multiplying the asset value by the risk weight associated with each respective asset.

17. The method of claim 10, wherein determining the candidate divestiture further comprises:
determining a capital ratio for each of the plurality of assets;
identifying one of the plurality of assets as having the highest capital ratio of the plurality of assets; and
determining that the asset having the highest capital ratio is the candidate divestiture.

18. The method of claim 10, further comprising:
identifying at least one of the plurality of assets as the candidate divestiture;
including at least one of a capital ratio, the risk weight, and the asset value associated with the at least one of the plurality of assets in the divestiture report; and
transmitting the divestiture report to a financial institution computing device associated with the financial institution.

19. A computer-readable storage medium having computer-executable instructions embodied thereon, wherein when executed by a computing device having one or more processors in communication with one or more memory devices, the computer-executable instructions cause the computing device to:
receive a divestiture request message including a financial institution identifier;
receive asset data for the identified financial institution, the asset data including data associated with a plurality of assets of the identified financial institution, wherein each asset has an asset value and a risk weight representing a potential change in the asset value over time;
determine a candidate divestiture for the identified financial institution at least in part based on the asset value and the risk weight for each asset of the plurality of assets; and
provide a divestiture report to the identified financial institution, wherein the divestiture report includes the candidate divestiture for the identified financial institution.

20. The computer-readable storage medium of claim 19, wherein said computer-executable instructions further cause the computing device to determine the asset value associated with at least one of the plurality of assets by determining a mark-to-market price of the at least one asset.
